(19) United States
(12) Patent Application Publication
(10) Pub. No.: US 2021/0231250 A1
(43) Pub. Date: Jul. 29, 2021

(54) SYSTEMS AND METHODS FOR THERMAL MANAGEMENT OF SUBSEA CONDUITS USING A SELF-DRAINING JUMPER

(71) Applicant: Chevron U.S.A. Inc., San Ramon, CA (US)

(72) Inventors: Antonio C.F. Critsinelis, Kingwood, TX (US); Sid MEBARKIA, Sugar Land, TX (US); Michelle A. WISE, Berkeley, CA (US); Yesudas J. MANIMALA, Katy, TX (US); William C. HUGHES, Houston, TX (US); Steven W. COCHRAN, Houston, TX (US); Edgar URIBE, Houston, TX (US); Jason D. GARCIA, Bellaire, TX (US)

(73) Assignee: Chevron U.S.A. Inc., San Ramon, CA (US)

(21) Appl. No.: 16/774,727

(22) Filed: Jan. 28, 2020

(51) Int. Cl. F16L 53/70

(52) U.S. Cl. CPC F16L 53/70

(57) ABSTRACT

Disclosed are systems and methods for thermal management of subsea conduits. A jumper that carries oil and/or gas produced from a subsea well in a subsea production facility located on a seabed has a first end for connecting to a first subsea component and a second end for connecting to a second subsea component. The jumper includes a jumper segment that is sloped relative to the horizontal, such that gravity assists with drainage of fluid from the second end of the jumper independent from fluid pressure in the jumper. At least a portion of the jumper is uninsulated to allow exchange of heat with seawater surrounding the jumper as produced fluid travels through the jumper. The amount of insulation on the jumper can be varied such that heat transfer from the production fluids to seawater surrounding the jumper circuit is adjusted as desired.

### FIELD

This disclosure relates generally to subsea oil and gas production facilities, and particularly to flowline jumpers extending between a subsea component and a subsea pipeline. The disclosure further relates to thermal management of such subsea pipeline using jumpers.

### BACKGROUND

The production of hydrocarbons from offshore oil and gas reservoirs requires the transportation of production fluids from the reservoirs to subsea facilities for processing. Three phases, i.e., oil, gas and water, may be included in the production fluids. Subsea developments increasingly must accommodate high temperature production fluids that need to be safely transported to the production facility. The high temperature of the production fluids can have several undesirable effects. Special grade subsea pipeline materials, extensive qualifications of insulation coating and expensive modifications topsides may be required to handle the high temperature of the product. For instance, water cooled heat exchangers may be used topsides on an offshore platform to reduce the temperature of production fluids, e.g., from around 400° F. to a temperature below 250° F., involving weight, space, cost, etc. In the subsea facility, the high temperature of the product may undesirably result in the occurrence of upheaval buckling, lateral buckling and pipeline walking in flowlines (also referred to as subsea pipeline or conduit) carrying the product. The temperature may also undesirably accelerate corrosion and therefore reduce the life of the flowlines. Attempts have been made at providing a subsea cooling system for use with gas production. No established oil or three phase subsea cooling system is available in the industry.

There exists a need for cost-effective subsea cooling systems and methods to enable the development of high temperature subsea fields without the disadvantages of known systems.

### SUMMARY

In general, in one aspect, the disclosure relates to a system for thermal management of a subsea conduit or pipeline that carries oil and/or gas produced from a subsea well in a subsea production facility located on a seabed. The system includes a jumper for carrying produced fluid, the jumper having a first end for connecting to a first subsea component, and a second end for connecting to a second subsea component. The jumper includes a jumper segment that is sloped relative to the horizontal, such that gravity assists with drainage of fluid from the second end of the jumper independent from fluid pressure in the jumper. At least a portion of the jumper is uninsulated to allow exchange of heat with seawater surrounding the jumper as produced fluid travels through the jumper.

In another aspect, the disclosure can generally relate to a method for thermal management of the subsea conduit in the subsea production facility. The method includes transmitting production fluids between subsea components in the jumper described above. The amount of insulation on the jumper can be varied such that heat transfer from the production fluids to seawater surrounding the jumper circuit is adjusted as desired.

### BRIEF DESCRIPTION OF THE DRAWINGS

These and other objects, features and advantages of the present invention will become better understood with reference to the following description, appended claims and accompanying drawings. The drawings are not considered limiting of the scope of the appended claims. Reference numerals designate like or corresponding, but not necessarily identical, elements. The drawings illustrate only example embodiments. The elements and features shown in the drawings are not necessarily to scale, emphasis instead being placed upon clearly illustrating the principles of the example embodiments. Additionally, certain dimensions or positionings may be exaggerated to help visually convey such principles.

FIG. 1 shows an example embodiment of a subsea jumper according to the prior art.

FIG. 2 shows an example embodiment of a self-draining jumper.

FIG. 3 shows another example embodiment of a self-draining jumper.

FIG. 4A shows an initially partially insulated jumper onto which insulation is installed later in life.

FIG. 4B shows a fully insulated jumper.

FIGS. 5A and 5B show an example of an insulation module for surrounding a self-draining jumper.

FIG. 6 shows an embodiment of an insulation module fabricated to allow installation on a jumper using an ROV handling tool.

### DETAILED DESCRIPTION

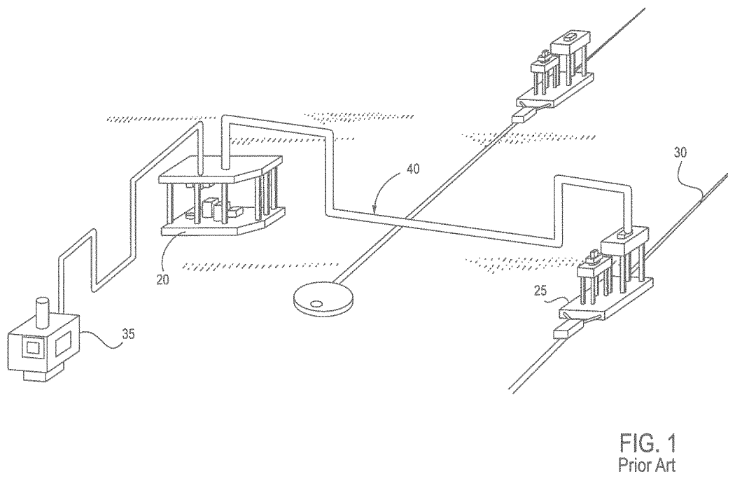

Referring to FIG. 1, a prior art subsea production facility is shown. A subsea pipeline 30 carries oil and/or gas produced from a subsea well 35 in the facility located on the seabed. A jumper 40 is connected to a first subsea component 20 (in this case, a manifold) and a second subsea component 25 (in this case, a pipeline end termination (PLET)). The subsea jumper 40 connects two different structures such as manifold and PLET to allow product flow to or from a subsea pipeline 30. The subsea pipeline 30 is connected to the pipeline end termination. The subsea jumper 40 typically consists of interconnected pipes, connectors, bends and insulation coating. The insulation (not shown) can ensure the product remains flowing above a certain temperature to avoid formation of waxes or hydrates that risk plugging the jumper pipe and stopping production. During shut down when production is stopped, the insulation is used to allow a minimum safe cool down time typically in the range of 12 to 16 hours to avoid formation of waxes of hydrates. As shown, the jumper 40 is shaped with a general M-shape to allow for safe thermal expansion as the temperature of the produced fluids increase through the jumper 40. This helps prevent thermal fatigue of the jumper 40.

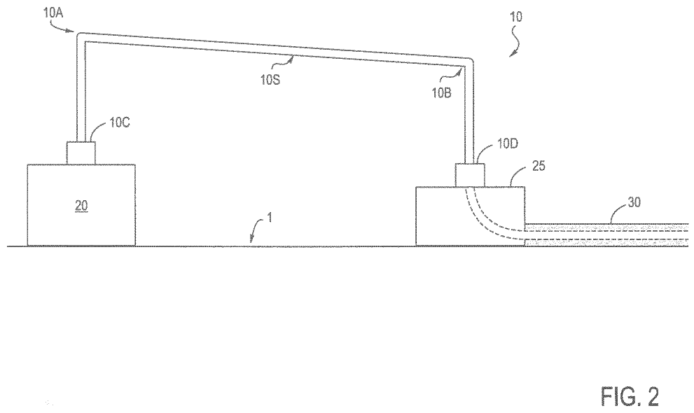

Systems and methods for thermal management of subsea pipeline 30 will be described. In one embodiment, referring to FIG. 2, a jumper 10, that carries oil and/or gas produced from a subsea well (not shown) in a subsea production facility is located on the seabed 1. A first end 10C of jumper 10 connects to a first subsea component 20 and a second end 10D of jumper 10 connects to a second subsea component 25, connected in turn to an insulated subsea pipeline 30. A segment of the jumper 10, 10S, has a first end 10A above and in fluid communication with 10C, and a second end 10B above and in fluid communication with 10D. The second end 10B is vertically lower than the first end 10A such that gravity assists with drainage of fluid from the second end 10B of the jumper segment 10S independent from fluid pressure in the jumper 10. Thus the jumper 10 has a shape that uses gravity to assist with drainage, and the jumper 10 is self-draining.

At least a portion (e.g., a segment 10S) of the jumper 10 is uninsulated to allow exchange of heat with the cooler seawater surrounding the jumper 10 as produced fluid travels through the jumper 10. In one embodiment, multiple jumpers 10 can be connected together to achieve the desired amount of cooling. Thus, hot produced fluids can cool as they are transmitted through the jumper(s) 10 to the insulated pipeline 30. As a result, the insulated pipeline 30 can be maintained within its qualified temperature range, i.e., temperature spikes can be avoided. Similarly, the platform arrival temperature can be maintained within its qualified temperature limits.

Furthermore, thermal expansion of the pipeline 30 can be avoided or minimized since use of the systems and methods of the disclosure reduce the temperature of produced fluids reaching the pipeline 30. Thus the effects of pipeline walking, lateral buckling or upheaval buckling can be avoided in the insulated pipeline 30, since these phenomena are known to be caused by thermal expansion of the pipeline.

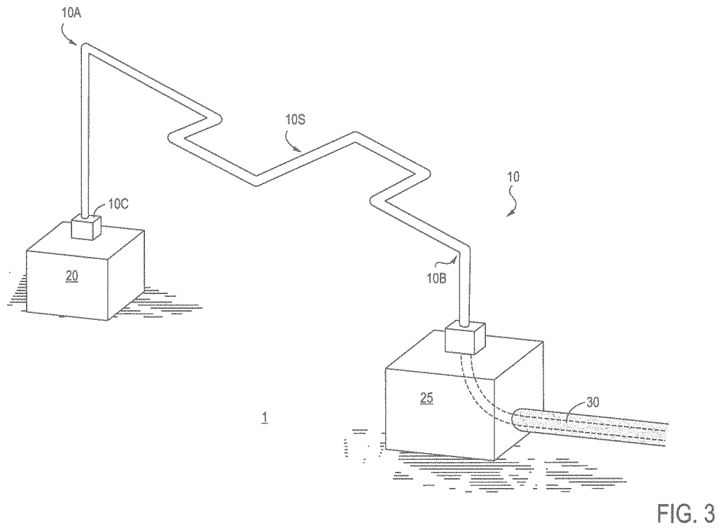

In one embodiment, the jumper 10 can be shaped in such a way that not only ensures self-drainage, but also thermal expansion. Referring to FIG. 3, the jumper segment 10S changes direction laterally with respect to an overall orientation of the jumper segment 10S between ends 10A and 10B. Over and along the length of the jumper segment 10S from the first end 10A to the second end 10B, the jumper 10 continuously decreases in a vertical height. In one embodiment (as shown), the jumper 10 can include a series of straight subsegments connected at distinct joints changing direction laterally. This may resemble a zigzag pattern when observed laterally. In one embodiment (not shown), the jumper 10 can include curved portions changing directions laterally. This may resemble an S-shaped pattern when observed laterally. The changes of direction allow for thermal expansion between the first and second ends (10A and 10B) of the jumper segment 10S.

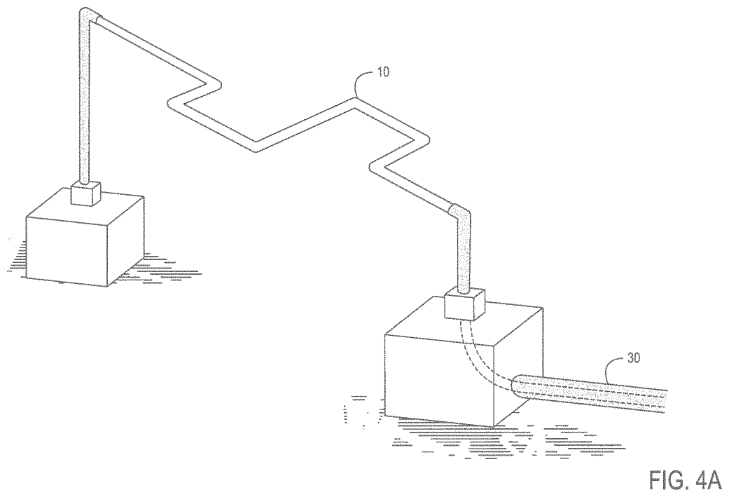

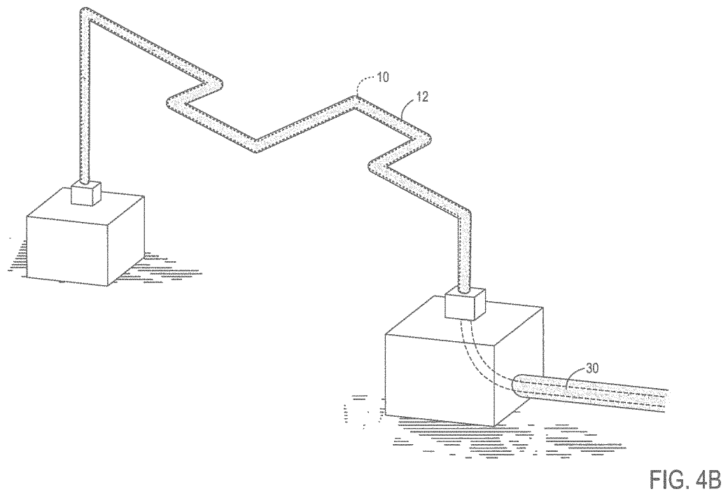

In one embodiment, the amount of insulation on the jumper 10 can be varied such that heat transfer from the production fluids to seawater surrounding the jumper 10 is adjusted as desired. For instance, in one embodiment, referring to FIG. 4A, the jumper 10 of FIG. 3 is initially partially insulated, and then as shown in FIG. 4B insulation 12 is installed on the uninsulated portion of the jumper 10 when the exchange of heat with seawater surrounding the jumper is no longer desirable. Depending on the phase of the life of the well or the stage of production, more or less insulation is desirable. For instance, the jumper 10 can go through an early or midlife stage in which the jumper 10 is partially insulated, i.e., partially bare and exposed to surrounding seawater for cooling. During shutdown, the jumper 10 can be filled with methanol to avoid flow assurance issues such as plugging. The jumper 10 can then go through a late life stage in which the product temperature reduces and cooling is not required. Cooling can then be prevented to avoid temperature falling below a flow assurance temperature limit that may cause plugging. For this reason, conventional jumpers (i.e., 40 in FIG. 1) are conventionally replaced with fully insulated piping (not shown).

However, such replacement of the jumper with fully insulated piping requires subsea vessel mobilization and shut down of the platform that results in loss of revenue. In order to avoid this shutdown of production and loss of revenue, during late life when the product temperature reduces and cooling is not required, referring to FIG. 4 an insulation module 12 can be installed on the uninsulated portion of the jumper 10.

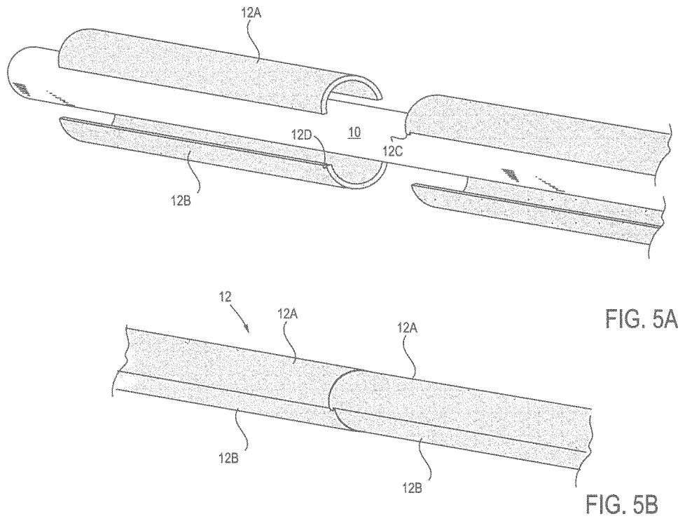

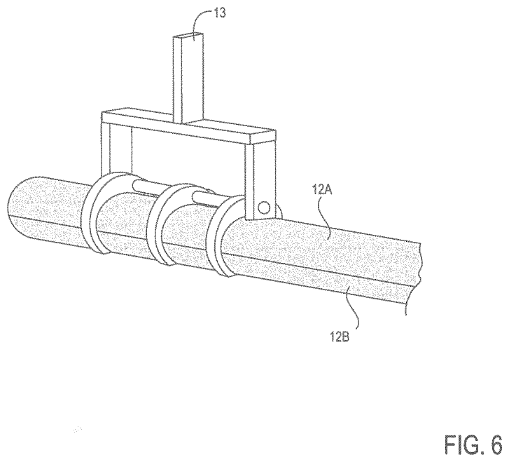

In one embodiment, referring to FIGS. 5A and 5B, the insulation module 12 can include two half shells 12A and 12B for surrounding the jumper 10. Interconnecting seams can be provided to connect the two half shells 12A and 12B on the jumper 10 circumferentially to form an installed insulation module 12. Interconnecting ends 12C and 12D can be provided to connect adjacent insulation modules 12 to one another on the jumper 10. In one embodiment, the insulation modules 12 are fabricated to allow installation on the jumper 10 using a remotely operated vehicle (ROV) (not shown), e.g., using an ROV handling tool 13 (see FIG. 6) to lift the insulation modules 12 from an ROV basket and install them on the jumper 12.

It should be noted that only the components relevant to the disclosure are shown in the figures, and that many other components normally part of a subsea oil and gas field are not shown for simplicity.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

What is claimed is:

1. A system for thermal management of a subsea pipeline system that carries oil and/or gas produced from a subsea well in a subsea production facility located on a seabed, comprising:
a jumper for carrying produced fluid having a first end for connecting to a first subsea component, and a second end for connecting to a second subsea component;
wherein the jumper includes a jumper segment having a first segment end above and in fluid communication with the first end and a second segment end above and in fluid communication with the second end, wherein the second segment end is vertically lower than the first segment end, such that gravity assists with drainage of fluid from the second end of the jumper independent from fluid pressure in the jumper; and
wherein at least a portion of the jumper is uninsulated to allow exchange of heat with seawater surrounding the jumper as produced fluid travels through the jumper.

2. The system of claim 1 wherein the second subsea component is connected to an insulated subsea pipeline.

3. The system of claim 1 wherein the jumper segment changes direction laterally with respect to an overall orientation of the jumper segment over at least a portion of a length of the jumper segment; and wherein over the length of the jumper segment from the first segment end to the second segment end, the jumper segment continuously decreases in vertical height.

4. The system of claim 1, further comprising an insulation module for installation on the uninsulated portion of the jumper when the exchange of heat with seawater surrounding the jumper is not desirable.

5. The system of claim 4 wherein the insulation module comprises two half shells for surrounding the jumper and wherein the half shells have interconnecting seams and interconnecting ends such that the half shells can be installed on the jumper to form an installed insulation module and multiple insulation modules can be installed on the jumper and connected to one another.

6. The system of claim 4 wherein the insulation module is installed on the jumper using a remotely operated vehicle (ROV).

7. A method for thermal management of a subsea pipeline system that carries oil and/or gas produced from a subsea well in a subsea production facility located on a seabed, comprising:
transmitting produced fluid in a jumper having a first end for connecting to a first subsea component, and a second end for connecting to an second subsea component;
wherein the jumper includes a jumper segment having a first segment end above and in fluid communication with the first end and a second segment end above and in fluid communication with the second end, wherein the second segment end is vertically lower than the first segment end, such that gravity assists with drainage of fluid from the second end of the jumper independent from fluid pressure in the jumper; and
wherein at least a portion of the jumper is uninsulated to allow exchange of heat with seawater surrounding the jumper as produced fluid travels through the jumper.

8. The method of claim 7 wherein the second subsea component is connected to an insulated subsea pipeline.

9. The method of claim 7 wherein the jumper segment changes direction laterally with respect to an overall orientation of the jumper segment over at least a portion of a length of the jumper segment; and wherein over the length of the jumper segment from the first segment end to the second segment end, the jumper segment continuously decreases in vertical height.

10. The method of claim 7, further comprising installing an insulation module on the uninsulated portion of the jumper when the exchange of heat with seawater surrounding the jumper is not desirable.

11. The method of claim 10 wherein the insulation module comprises two half shells for surrounding the jumper and wherein the half shells have interconnecting seams and interconnecting ends such that the half shells can be installed on the jumper to form an installed insulation module and multiple insulation modules can be installed on the jumper and connected to one another.

12. The method of claim 10 wherein the insulation module is installed on the jumper using a remotely operated vehicle (ROV).
